(19) United States
(12) Patent Application Publication
(10) Pub. No.: US 2024/0396774 A1
(43) Pub. Date: Nov. 28, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Yihua MA, Shenzhen (CN); Zhifeng YUAN, Shenzhen (CN); Weimin LI, Shenzhen (CN); Zhigang LI, Shenzhen (CN)

(21) Appl. No.: 18/792,475

(22) Filed: Aug. 1, 2024

Related U.S. Application Data
(63) Continuation of application No. PCT/CN2022/103474, filed on Jul. 1, 2022.

(51) Int. Cl. H04L 27/26; H04L 5/00

(52) U.S. Cl. CPC H04L 27/26025; H04L 5/0007

(57) ABSTRACT

Method, device and computer program product for wireless communication are provided. A method includes: receiving, by a wireless communication terminal from a wireless communication node, a broadcast signal; and backscattering, by the wireless communication terminal, an excitation signal according to the broadcast signal to generate a backscatter signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

### CROSS-REFERENCE TO RELATED APPLICATIONS

The present application is a bypass continuation application of International Application No. PCT/CN2022/103474, filed on Jul. 1, 2022, which is hereby incorporated by reference in its entirety.

### TECHNICAL FIELD

This document is directed generally to wireless communications, in particular to 5th generation (5G) or 6th generation (6G) wireless communication.

### BACKGROUND

Backscatter communication, or passive IoT (Internet of Things) is able to reduce the power consumption and cost of IoT. In IoT or MTC (Machine-type communications), there can be many users transmitting sporadic short packets. However, some backscatter communication schemes may only support the communication of one or a few users at one time, which causes inefficiency.

### SUMMARY

The present disclosure relates to methods, devices, and computer program products for backscatter communications.

One aspect of the present disclosure relates to a wireless communication method. In an embodiment, the wireless communication method includes: receiving, by a wireless communication terminal from a wireless communication node, a broadcast signal; and backscattering, by the wireless communication terminal, an excitation signal according to the broadcast signal to generate a backscatter signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

Another aspect of the present disclosure relates to a wireless communication method. In an embodiment, the wireless communication method includes: transmitting, by a wireless communication node to a wireless communication terminal, an excitation signal to make the wireless communication terminal to generate a backscatter signal by backscattering the excitation signal, wherein excitation signal is on a first orthogonal frequency-division multiplexing, OFDM, subcarrier, and the backscatter signal is on second OFDM subcarriers associated with a frequency of the first OFDM subcarrier and a subcarrier spacing.

Another aspect of the present disclosure relates to a wireless communication method. In an embodiment, the wireless communication method includes: receiving, by a wireless communication node from a wireless communication terminal, a backscatter signal generated by backscattering an excitation signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

Another aspect of the present disclosure relates to a wireless communication terminal. In an embodiment, the wireless communication terminal includes a communication unit and a processor. The processor is configured to: receive, from a wireless communication node, a broadcast signal; and backscatter an excitation signal according to the broadcast signal to generate a backscatter signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

Another aspect of the present disclosure relates to a wireless communication node. In an embodiment, the wireless communication node includes a communication unit and a processor. The processor is configured to: transmit, to a wireless communication terminal, an excitation signal to make the wireless communication terminal to generate a backscatter signal by backscattering the excitation signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

Another aspect of the present disclosure relates to a wireless communication node. In an embodiment, the wireless communication node includes a communication unit and a processor. The processor is configured to: receive, from a wireless communication terminal, a backscatter signal generated by backscattering an excitation signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

Various embodiments may preferably implement the following features:

Preferably, the wireless communication terminal backscatters the excitation signal according to a resource indicator in the broadcast signal.

Preferably, the resource indicator indicates at least one of: one or more available subcarriers, one or more available time symbols or frames, a number of available time symbols or frames, or an allocation of specific resources for specific users.

Preferably, the second OFDM subcarriers have frequencies of f₀−N×Δf and f₀+N×Δf wherein f₀ denotes the frequency of the first OFDM subcarrier, and Δf denotes the subcarrier spacing.

Preferably, N is a positive integer,

Preferably, the range of N is a proper subset of integers {1, 2, . . . , Nₘₐₓ}, and Nₘₐₓ is the maximum value of N.

Preferably, N satisfies N>B_{G}/Δf, wherein B_{G} is a guardband bandwidth between the excitation signal and the backscatter signal.

Preferably, N is between a value range with a maximum max(N) and a minimum min(N), and min(N) is larger than max(N)/3.

Preferably, N is fixed or variable during one backscattering transmission.

Preferably, N is randomly selected by the wireless communication terminal.

Preferably, the backscatter signal is generated by using the excitation signal and a square-wave subcarrier.

Preferably, the square-wave subcarrier has a frequency of N×Δf, Δf denotes the subcarrier spacing.

Preferably, the square-wave subcarrier is a 1-bit quantization of a sine wave or a cosine wave.

Preferably, the first OFDM subcarrier is a direct current, DC, subcarrier.

Preferably, the subcarrier spacing is determined according to a synchronization reference signal in the broadcast signal.

Preferably, the subcarrier spacing is determined according to a subcarrier spacing indicator in the broadcast signal.

Preferably, the subcarrier spacing is equal to 15/2^{u} kHz, and u is an integer not smaller than 0.

Preferably, the excitation signal is transmitted by the wireless communication node or another wireless communication node.

Preferably, the backscatter signal is transmitted to a wireless communication node identical to or different from the wireless communication node transmitting the excitation signal.

Preferably, the wireless communication node transmits a broadcast signal comprising a resource indicator to allow the wireless communication terminal to backscatter the excitation signal according to a resource indicator in the broadcast signal.

Preferably, the wireless communication node transmits a broadcast signal comprising a synchronization reference signal for determining the subcarrier spacing.

Preferably, the wireless communication node transmits a broadcast signal comprising a subcarrier spacing indicator for determining the subcarrier spacing.

Preferably, the wireless communication node performs a linear transform to the backscatter signal after a Fast Fourier Transformation, FFT, of the backscatter signal and before a demodulation of the backscatter signal.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a diagram of a frequency spectrum of a square wave according to an embodiment of the present disclosure.

FIG. 2 shows a diagram of a backscatter communication according to an embodiment of the present disclosure.

FIG. 3 shows another diagram of a backscatter communication according to an embodiment of the present disclosure.

FIG. 4 shows another diagram of a backscatter communication according to an embodiment of the present disclosure.

FIG. 5 shows another diagram of a backscatter communication according to an embodiment of the present disclosure.

FIG. 6 shows another diagram of a backscatter communication according to an embodiment of the present disclosure.

FIG. 7 shows another diagram of a backscatter communication according to an embodiment of the present disclosure.

FIGS. 8a and 8b show a backscatter communication according to an embodiment of the present disclosure.

FIGS. 9a and 9b show the broadcast signal according to different embodiments of the present disclosure.

FIG. 10 shows a diagram of a linear transform according to an embodiment of the present disclosure.

FIG. 11 shows another diagram of a linear transform according to an embodiment of the present disclosure.

FIG. 12 shows a schematic diagram of a wireless communication terminal according to an embodiment of the present disclosure.

FIG. 13 shows a schematic diagram of a wireless communication node according to an embodiment of the present disclosure.

### DETAILED DESCRIPTION

Applying OFDM for backscatter communication can support more users/tags. However, due to the limitation of low-cost and low-power tag, directly applying OFDM suffers from bad performance. An embodiment of the present disclosure uses double side-band (DSB) transmission in OFDM scheme as DSB can be realized by very simple backscatter modulation circuit. In such a DSB-based OFDM, the subcarrier relationship of excitation signal and backscatter signal can be modulated. Besides, further configurations can be applied to the OFDM for separating the excitation signal and backscatter signal, so as to reduce interference caused by the modulation circuit of the tag.

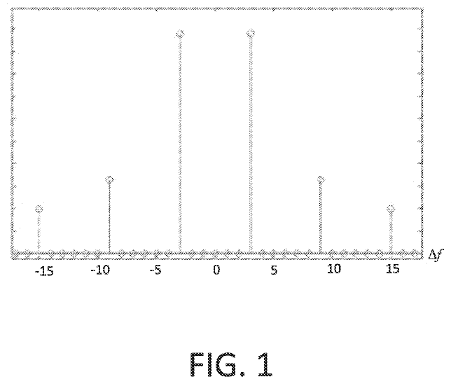

For example, as illustrated in FIG. 1, a square wave with a frequency of Nₖ×Δf leads to a backscatter signal not only shifting by ±Nₖ×Δf but also by ±3Nₖ×Δf, f₀±5Nₖ×Δf, and so on (in this case, Nₖ is 3). As the interference pattern can be known in advance, some subcarriers can be avoided to reduce interference.

In some embodiments, in passive RFID (radio frequency identification), the subcarrier concept is not the same as that in OFDM. For example, in the EPCgen standard, the subcarrier of tag can be on 40 kHz to 640 kHz, which is indicated by an indicator in the Query command sent from the reader. The number of subcarrier cycles per symbol is decided based on the subcarrier and another indicator in the Query command. Accordingly, the RFID tags selecting different subcarriers for transmission may have different subcarrier lengths per symbol. However, in OFDM, subcarrier lengths are identical. Besides, the concept of multiple subcarrier multiple access in passive RFID is also different from OFDM, as OFDM has a specific relationship between the OFDM subcarrier spacing and OFDM symbol time.

### Embodiment 1

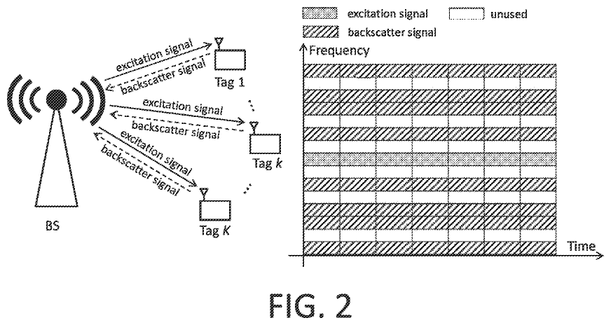

FIG. 2 shows a diagram of a backscatter communication according to an embodiment of the present disclosure.

As shown in FIG. 2, a BS (base station) transmits an excitation signal to K (K≥1) tags at the OFDM subcarrier with a frequency f₀, and the K tags modulate information in the backscatter signals by adjusting the reflection coefficients. To avoid strong interference of the excitation signal, the frequency of backscatter signal is shifted using the subcarrier generated by the tag. The generated subcarrier is a real-number square wave. The backscatter signal of the k-th tag uses a pair of OFDM subcarriers with frequencies, f₀−Nₖ×Δf and f₀+Nₖ×Δf, where K≥1, 1≤k≤K, Nₖ is an OFDM subcarrier shift index selected by the k-th user, and Δf is the OFDM subcarrier spacing. Subcarrier f₀ can be a DC (direct current) subcarrier. For Tag k, each modulation symbol is modulated in each OFDM symbol at the Tag k's subcarrier pair. In some embodiments, the square wave may have frequency leakage on other OFDM subcarriers (e.g., as illustrated in FIG. 1). In such embodiments, this frequency interference is allowed and can be reduced by some receiving algorithms.

In another aspect, the backscatter signals of the tags use pairs of OFDM subcarriers with frequencies of f₀−N×Δf and f₀+N×Δf, wherein the range of N is a proper subset of integer {1, 2, . . . , Nₘₐₓ}, and Nₘₐₓ is the maximum value of N.

In an embodiment, all OFDM subcarriers apart from the excitation signal in the applicable bandwidth range can be used. Tag k randomly selects the available OFDM subcarriers and time occasions to backscatter the excitation signal. There can be some available OFDM subcarriers not selected by any tag, which is marked as the unused OFDM subcarriers in FIG. 2. In some embodiments, there can also be no unused OFDM subcarriers if all OFDM subcarriers are selected by the tags.

### Embodiment 2

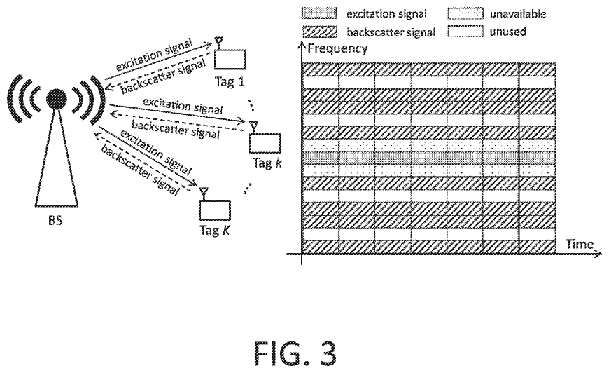

FIG. 3 shows a diagram of a backscatter communication according to an embodiment of the present disclosure.

As shown in FIG. 3, a BS transmits an excitation signal to K (K≥1) tags at the OFDM subcarrier with a frequency f₀, and the K tags modulate information in the backscatter signals by adjusting the reflection coefficients. To avoid strong interference of the excitation signal, the frequency of the backscatter signal is shifted using the subcarrier generated by the tag. The generated subcarrier is a real-number square wave. The backscatter signal of the k-th tag uses a pair of OFDM subcarriers with frequencies, f₀−Nₖ×Δf and f₀+Nₖ×Δf, where K≥1, 1≤k≤K, Nₖ is an OFDM subcarrier shift index selected by the k-th user, and Δf is the OFDM subcarrier spacing. Subcarrier f₀ can be a DC (direct current) subcarrier. For Tag k, each modulation symbol is modulated in each OFDM symbol at the Tag k's subcarrier pair. In some embodiments, the square wave may have frequency leakage on other OFDM subcarriers (e.g., as illustrated in FIG. 1). In such embodiments, this frequency interference is allowed and can be reduced by some receiving algorithms.

In another aspect, the backscatter signals of the tags use pairs of OFDM subcarriers with frequencies of f₀−N×Δf and f₀+N×Δf, wherein the range of N is a proper subset of integer {1, 2, . . . , Nₘₐₓ}, and Nₘₐₓ is the maximum value of N.

In this embodiment, a guardband is inserted between the excitation signal and backscatter signal, which is marked as unavailable OFDM subcarriers in FIG. 3. The bandwidth of the one-side guardband is Δf in FIG. 3, but another bandwidth is also possible based on the actual requirements. In this embodiment, all OFDM subcarriers apart from the excitation signal and unavailable OFDM subcarriers in the bandwidth range may be used. Tag k randomly selects the available OFDM subcarriers and time occasions to backscatter the excitation signal. There can be some available OFDM subcarriers not selected by any tag, which is marked as the unused OFDM subcarriers in FIG. 3. In some embodiment, there can also be no unused OFDM subcarriers if all OFDM subcarriers are selected by the tags.

In an embodiment, Nₖ>B_{G}/Δf, wherein B_{G} is the guardband bandwidth between the excitation signal and the backscatter signal.

### Embodiment 3

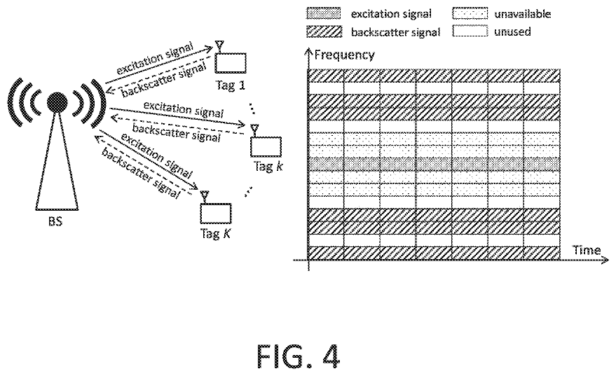

FIG. 4 shows a diagram of a backscatter communication according to an embodiment of the present disclosure.

As shown in FIG. 3, a BS transmits an excitation signal to K (K≥1) tags at the OFDM subcarrier with a frequency f₀, and the K tags modulate information in the backscatter signals by adjusting the reflection coefficients. To avoid strong interference of the excitation signal, the frequency of backscatter signal is shifted using the subcarrier generated by the tag. The generated subcarrier is a real-number square wave. The backscatter signal of the k-th tag uses a pair of OFDM subcarriers with frequencies, f₀−Nₖ×Δf and f₀+Nₖ×Δf, where K≥1, 1≤k≤K, Nₖ is an OFDM subcarrier shift index selected by the k-th user, and Δf is the OFDM subcarrier spacing. Subcarrier f₀ can be a DC (direct current) subcarrier. For Tag k, each modulation symbol is modulated in each OFDM symbol at the Tag k's subcarrier pair. In some embodiments, the square wave may have frequency leakage on other OFDM subcarriers (e.g., as illustrated in FIG. 1). In this embodiment, the frequency interference caused by the frequency leakage can be avoided by limiting min (Nₖ)>max (Nₖ)/3, in which min (Nₖ) denotes the minimum of Nₖ, and max (Nₖ) denotes the maximum of Nₖ.

In another aspect, the backscatter signals of the tags use pairs of OFDM subcarriers with frequencies of f₀−N×Δf and f₀+N×Δf, wherein the range of N is a proper subset of integer {1, 2, . . . , Nₘₐₓ}, and Nₘₐₓ is the maximum value of N.

In this embodiment, the limitation of Nₖ leads to some unavailable OFDM subcarriers as shown in FIG. 4. In this embodiment, all OFDM subcarriers apart from the excitation signal and unavailable OFDM subcarriers in the bandwidth range may be used. Tag k randomly selects the available OFDM subcarriers and time occasions to backscatter the excitation signal. There can be some available OFDM subcarriers not selected by any tag, which is marked as the unused OFDM subcarriers in FIG. 3. In some embodiment, there can also be no unused OFDM subcarriers if all OFDM subcarriers are selected by the tags.

### Embodiment 4

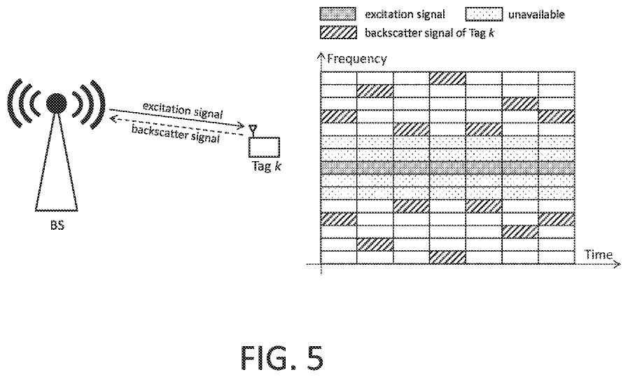

FIG. 5 shows a diagram of a backscatter communication according to an embodiment of the present disclosure.

In the previous embodiments (i.e., Embodiments 1 to 3), a tag may use a fixed pair of fixed OFDM subcarriers carrying the backscatter signal during a backscattering transmission (e.g., Nₖ is fixed during a backscattering transmission). In this embodiment, variable OFDM subcarriers, or frequency hopping, may be used for transmitting the backscatter signal. Variable OFDM subcarriers or frequency hopping can be applied to the previous embodiments. As shown in FIG. 5, Tag k uses a variable OFDM subcarrier pair in different symbols or in different replicas when it is a repetition transmission. The frequency hopping pattern can be preconfigured or assigned by the BS. That is, in an embodiment, Nₖ can be varied during one backscattering transmission.

### Embodiment 5

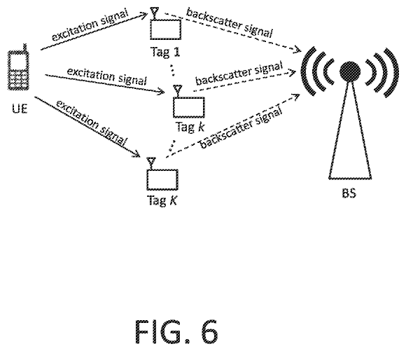

FIG. 6 shows a diagram of a backscatter communication according to an embodiment of the present disclosure.

In the previous embodiments (i.e., Embodiments 1 to 4), the transmitter of the excitation signal and the receiver of the backscatter signal is the same node. In this embodiment, the transmitter of the excitation signal and the receiver of the backscatter signal are different nodes, and such a configuration can be easily applied to the previous embodiments. As shown in FIG. 5, a UE (user equipment) transmits the excitation signal, while a BS receives the backscatter signal.

### Embodiment 6

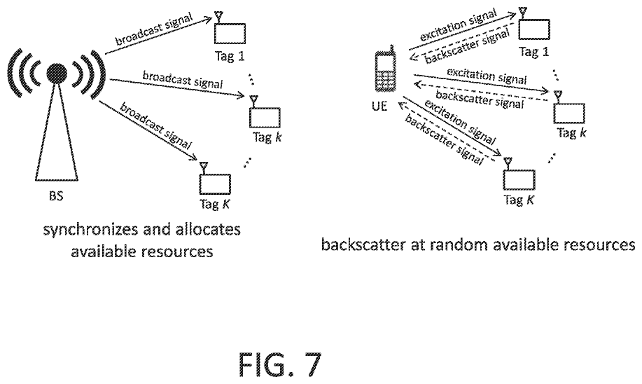

FIG. 7 shows a diagram of a backscatter communication according to an embodiment of the present disclosure.

In the previous embodiments (i.e., Embodiments 1 to 4), the tags randomly select available OFDM subcarriers and time occasions to transmit. That is to say, the contention-based resource selection is used, which can be a slotted ALOHA-based protocol. The available OFDM subcarriers and time occasions may be flexible for user loading. For the flexible resource allocation, a BS broadcasts at least one of a synchronization reference signal and/or a resource indication. The tags synchronize with the broadcast signal and randomly select the available resources according to the resource indication. Then, another node, which can be an active UE or another BS, transmits an excitation signal, and the tags backscatter the excitation signal in the selected resources.

In an embodiment, the resource indication can indicate the number of available time occasions, and this number can be adjusted according to the loading. When there are many tags, the number can be large. When there are a few tags, the number can be small.

### Embodiment 7

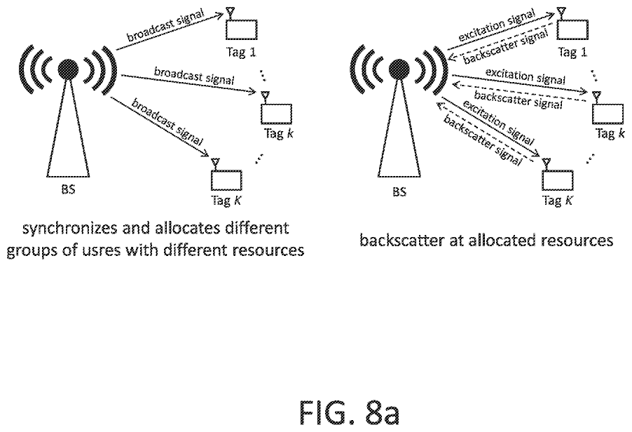

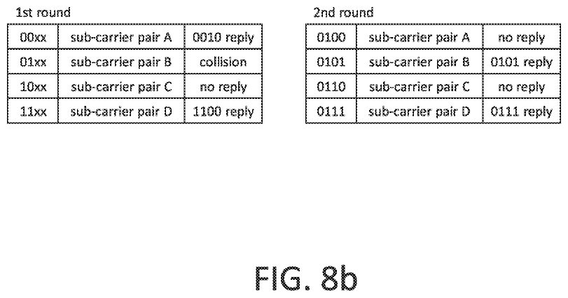

FIGS. 8a and 8b show a backscatter communication according to an embodiment of the present disclosure.

In the previous embodiments, the tags randomly select available OFDM subcarriers and time occasions. This embodiment uses a deterministic resource allocation, such as using a binary tree-based protocol. The BS broadcasts a broadcast signal with a synchronization reference signal and a resource indicator which allocates different groups of tags with different resources (e.g., different subcarriers). In an embodiment, the resource indicator indicates at least one of: one or more available subcarriers, one or more available time symbols or frames, a number of available time symbols or frames, and/or an allocation of specific resources for specific users. The tags synchronize with the broadcast signal and select the allocated resources. Then, this BS transmits the excitation signal, and tags backscatter the excitation signal in the allocated resources.

As showed in FIG. 8b, an example of binary tree-based protocol is provided. Assuming that the tags with the IDs of 0010, 0101, 0111 and 1100 are in the coverage of the BS, in the first round, the BS allocates 00xx, 01xx, 10xx and 11xx with the OFDM subcarrier pairs A, B, C and D. Two tags with the IDs of 0010 and 1100 are successfully detected on the OFDM subcarrier pairs A and D, and a collision is detected on the OFDM subcarrier pair B. According to the detected collision, in the second round, the BS allocates 0100, 0101, 0110 and 0111 with the OFDM subcarrier pairs A, B, C and D. The tags with the IDs of 0101 and 0111 are detected on the OFDM subcarrier pairs B and D, and no collision is detected. Accordingly, the transmission ends.

### Embodiment 8

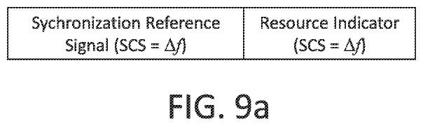

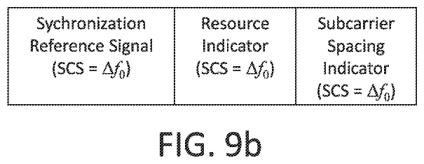

FIGS. 9a and 9b show the broadcast signal according to different embodiments of the present disclosure.

There are some methods for indicating the SCS (subcarrier spacing) Δf in the broadcast signal. In an embodiment, the synchronization reference signal may carry the information of the subcarrier spacing Δf. That is, the synchronization reference signal is not only used for synchronization but also used to decide the subcarrier spacing Δf. In an alternative embodiment, a fixed subcarrier spacing Δf₀ is used by the broadcast signal for synchronization, and the broadcast signal includes a subcarrier spacing indicator carrying the information of the subcarrier spacing (i.e., the SCS=Δf₀), to allow the tags to decide the subcarrier spacing.

### Embodiment 9

This embodiment shows how a tag generates a square wave subcarrier. As the frequency of the clock of a tag is limited, the tag may be not able to generate the square wave when the clock frequency is not an integral multiple of the subcarrier frequency. In this embodiment, 1-bit quantization is used to generate the square wave, which can be written as:

$${x}_{sc} [ l ] = \{ \begin{matrix}1 , sin ( ω \frac{l}{L} {T}_{S} ) \geq 0. \\ 0 , sin ( ω \frac{l}{L} {T}_{S} ) < 0\end{matrix} .$$

where l=0, 1, 2, . . . , L−1, 1 is the index of sampling points, L is an integer, w is the angle frequency of the subcarrier, Ts is the time duration of one sampling point. As it is unequal to quantize all 0 values to 1, an alternative way to quantize the sine wave is:

$${x}_{sc} [ l ] = \{ \begin{matrix}1 , sin ( ω \frac{l}{L} {T}_{S} + τ ) > 0. \\ 0 , sin ( ω \frac{l}{L} {T}_{S} + τ ) < 0\end{matrix} .$$

where t is introduced to avoid sine function equaling to 0 for l=0, 1, 2, . . . , L−1. It can also be written as:

$${x}_{sc} [ l ] = \{ \begin{matrix}1 , sin ( ω \frac{l}{L} {T}_{S} ) > 0 or ( sin ( ω \frac{l}{L} {T}_{S} ) = 0 and {sin}^{′} ( ω \frac{l}{L} {T}_{S} ) > 0 ) . \\ 0 , sin ( ω \frac{l}{L} {T}_{S} ) < 0 or ( sin ( ω \frac{l}{L} {T}_{S} ) = 0 and {sin}^{′} ( ω \frac{l}{L} {T}_{S} ) < 0 )\end{matrix} .$$

where the sin′ (x) is the derivative function of sin (x).

In some embodiments, the sine functions in the embodiment described above can be replaced by cosine functions.

### Embodiment 10

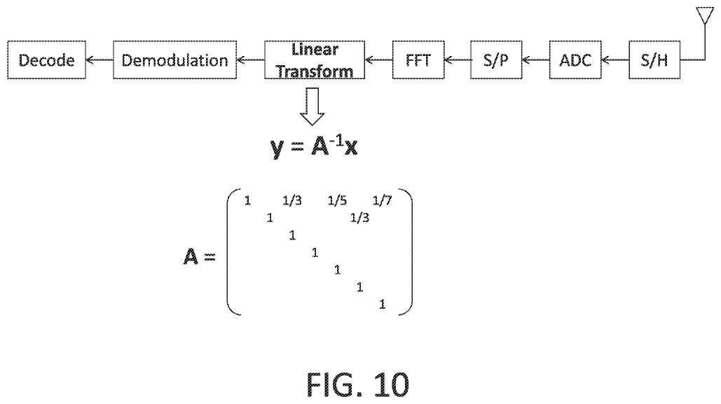

As illustrated in FIG. 10, the receiver of the backscatter signal may perform an S/H (sample-and-hold) process, an ADC (analog to digital convert) process, an S/P (serial to parallel) process, an FFT (Fast Fourier Transform) process, a linear transform, a demodulation process, and a decode process. In an embodiment, the linear transform is performed between the FFT (Fast Fourier Transform) and demodulation processes. The linear transform is used to reduce the inter-carrier interference (ICI) caused by the square wave subcarrier. The square wave with a period of 2π equals to the Fourier series of sin(x)+sin(3x)/3+sin(5x)/5+ . . . , and since this interference is known before the demodulation, the linear transform inversing the interference matrix can be added to reduce the ICI. An interference matrix with N=1 to 7 is illustrated in FIG. 10.

### Embodiment 11

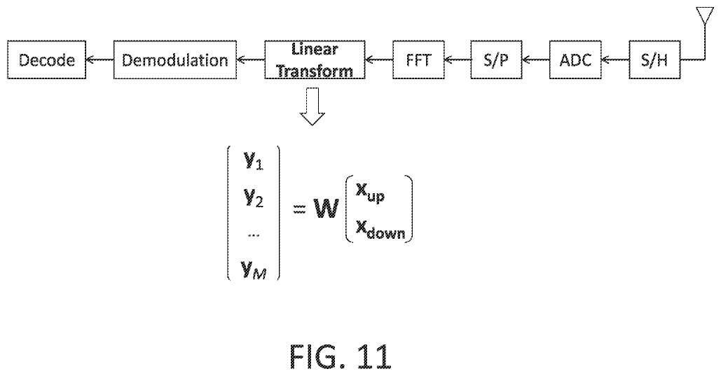

As illustrated in FIG. 11, the receiver of the backscatter signal may perform an S/H (sample-and-hold) process, an ADC (analog to digital convert) process, an S/P (serial to parallel) process, an FFT (Fast Fourier Transform) process, a linear transform, a demodulation process, and a decode process. In an embodiment, the linear transform is performed between the FFT (Fast Fourier Transform) and demodulation processes. The linear transform is to combine the up sideband and down sideband. As different users have different coefficient vectors at the two sidebands, the receiver can use a combine coefficient to strengthen the signal of one specific user. In FIG. 11, the two sidebands of the signal are linearly combined, and M streams of signal can be obtained. In an embodiment, the matrix W is based on channel estimation or a predefined scanning vector.

According to an embodiment of the present disclosure, a method for wireless communications performed by at least one user equipment (UE) is provided. The method comprises: receiving a broadcast signal including a synchronization reference signal and a resource indicator, synchronizing with the synchronization reference signal, and selecting the resource to backscatter according to the resource indicator; and backscattering a single-tone excitation signal, where the single-tone excitation signal is at the OFDM subcarrier f₀, and the backscatter signal has at least partial power at the OFDM subcarrier f₀−N×Δf and f₀+N×Δf, where N is an integer, and Δf is the subcarrier spacing.

According to an embodiment of the present disclosure, the value range of N is a proper subset of {1, 2, 3, . . . , max(N)}.

According to an embodiment of the present disclosure, all the values of N satisfy N>B_{G}/Δf, where B_{G} is the guardband bandwidth between the single-tone signal and backscatter signal.

According to an embodiment of the present disclosure, all the values of N satisfy min(N)>max(N)/3.

According to an embodiment of the present disclosure, the subcarrier f₀ is the DC subcarrier.

According to an embodiment of the present disclosure, N is fixed or variable in a backscattering transmission.

According to an embodiment of the present disclosure, the value of N is randomly selected by the UE.

According to an embodiment of the present disclosure, the resource indicator indicates at least one of: which subcarriers are available, which time symbols or frames are available, how many time symbols or frames are available, and the allocation of specific resources for specific users.

According to an embodiment of the present disclosure, the backscatter signal is generated by the excitation signal and a square-wave subcarrier of frequency N×Δf, the square-wave subcarrier is a 1-bit quantization of sine wave or cosine wave.

According to an embodiment of the present disclosure, the UE uses the synchronization reference signal to decide the subcarrier spacing.

According to an embodiment of the present disclosure, the broadcast signal comprises a subcarrier spacing indicator and UE use it to decide the subcarrier spacing.

According to an embodiment of the present disclosure, Δf=15/2^{u} (i.e., 15/(2\hat{ }u)) kHz, where u is an integer not smaller than 0.

According to an embodiment of the present disclosure, a first node transmits the single-tone excitation signal at the subcarrier f₀ of OFDM, and the second node receives the backscatter signal including signal components at the subcarrier f₀−N×Δf and f₀+N×Δf of OFDM, where N is an integer, and Δf is the subcarrier spacing.

According to an embodiment of the present disclosure, the first node and second node are the same node.

According to an embodiment of the present disclosure, the receiver makes a linear transform to the signal after the FFT of the OFDM and before demodulation.

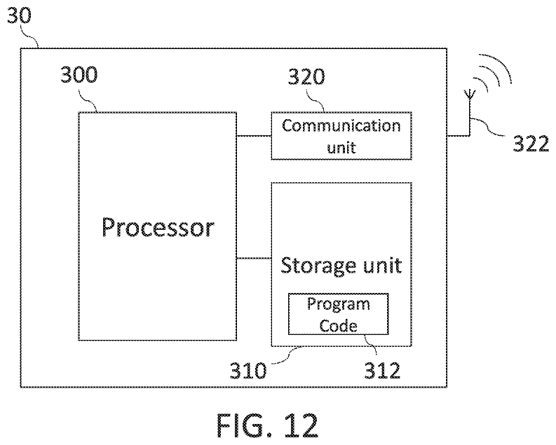

FIG. 12 relates to a diagram of a wireless communication terminal 30 (e.g., a terminal node or a terminal device) according to an embodiment of the present disclosure. The wireless communication terminal 30 may be a tag, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of one of the tags described above. In some embodiments, the processor 300 and the communication unit 320 collaboratively perform the operations described above. For example, the processor 300 performs operations and transmit or receive signals, message, and/or information through the communication unit 320.

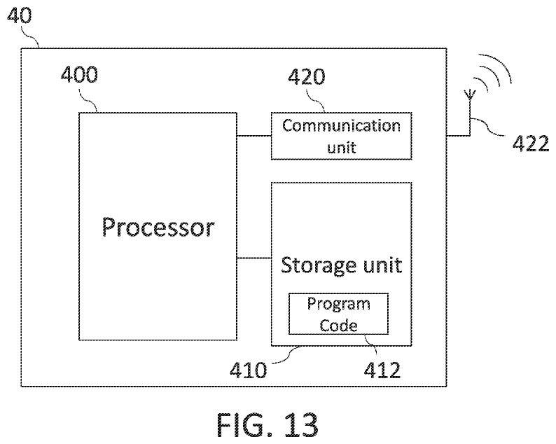

FIG. 13 relates to a diagram of a wireless communication node 40 (e.g., a network device) according to an embodiment of the present disclosure. The wireless communication node 40 may be a user equipment (UE), a satellite, a base station (BS), a gNB, a network entity, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the BS or the UE described above. In some embodiments, the processor 400 and the communication unit 420 collaboratively perform the operations described above. For example, the processor 400 performs operations and transmit or receive signals through the communication unit 420.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
receiving, by a wireless communication terminal from a wireless communication node, a broadcast signal; and
backscattering, by the wireless communication terminal, an excitation signal according to the broadcast signal to generate a backscatter signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

2. The wireless communication method of claim 1, wherein the wireless communication terminal backscatters the excitation signal according to a resource indicator in the broadcast signal.

3. The wireless communication method of claim 2, wherein the resource indicator indicates at least one of: one or more available subcarriers, one or more available time symbols or frames, a number of available time symbols or frames, or an allocation of specific resources for specific users.

4. The wireless communication method of claim 1, wherein the second OFDM subcarriers have frequencies of f₀−N×Δf and f₀+N×Δf, wherein N is a positive integer, f₀ denotes the frequency of the first OFDM subcarrier, and Δf denotes the subcarrier spacing.

5. The wireless communication method of claim 4, wherein the range of N is a proper subset of {1, 2, . . . , Nₘₐₓ}, and Nₘₐₓ is the maximum value of N.

6. The wireless communication method of claim 4, wherein N satisfies N>B_{G}/Δf, wherein B_{G} is a guardband bandwidth between the excitation signal and the backscatter signal.

7. The wireless communication method of claim 5, wherein Nis between a value range with a maximum max(N) and a minimum min(N), and min(N) is larger than max(N)/3.

8. The wireless communication method of claim 5, wherein N is fixed or variable during one backscattering transmission.

9. The wireless communication method of claim 5, wherein N is randomly selected by the wireless communication terminal.

10. The wireless communication method of claim 1, wherein the backscatter signal is generated by using the excitation signal and a square-wave subcarrier.

11. The wireless communication method of claim 10, wherein the square-wave subcarrier has a frequency of N×Δf, Δf denotes the subcarrier spacing, and the square-wave subcarrier is a 1-bit quantization of a sine wave or a cosine wave.

12. The wireless communication method of claim 1, wherein the first OFDM subcarrier is a direct current, DC, subcarrier.

13. The wireless communication method of claim 1, wherein the subcarrier spacing is determined according to a synchronization reference signal in the broadcast signal.

14. The wireless communication method of claim 1, wherein the subcarrier spacing is determined according to a subcarrier spacing indicator in the broadcast signal.

15. The wireless communication method of claim 1, wherein the subcarrier spacing is equal to 15/2^{u} kHz, and u is an integer not smaller than 0.

16. The wireless communication method of claim 1, wherein the excitation signal is transmitted by the wireless communication node or another wireless communication node.

17. The wireless communication method of claim 16, wherein the backscatter signal is transmitted to a wireless communication node identical to or different from the wireless communication node transmitting the excitation signal.

18. A wireless communication method comprising:
transmitting, by a wireless communication node to a wireless communication terminal, an excitation signal to make the wireless communication terminal to generate a backscatter signal by backscattering the excitation signal, wherein excitation signal is on a first orthogonal frequency-division multiplexing, OFDM, subcarrier, and the backscatter signal is on second OFDM subcarriers associated with a frequency of the first OFDM subcarrier and a subcarrier spacing.

19. A wireless communication terminal, comprising:
a communication unit; and
a processor configured to: receive, from a wireless communication node, a broadcast signal; and backscatter an excitation signal according to the broadcast signal to generate a backscatter signal, wherein the excitation signal is on a first orthogonal frequency-division multiplexing, OFDM, subcarrier, and the backscatter signal is on second OFDM subcarriers associated with a frequency of the first OFDM subcarrier and a subcarrier spacing.

20. A computer program product comprising a non-volatile computer-readable program medium code stored thereupon, the code, when executed by a processor, causing the processor to implement a wireless communication method recited in claim 1.
